(19) United States
(12) Patent Application Publication
(10) Pub. No.: US 2008/0228107 A1
(43) Pub. Date: Sep. 18, 2008

(54) BIO-TESTING BOOTH

(76) Inventor: Venkateshwara N Reddy, Cupertino, CA (US)

Correspondence Address: HAHN AND MOODLEY, LLP, P.O. BOX 52050, MINNEAPOLIS, MN, 55402, US

(21) Appl. No.: 11/684,760

(22) Filed: Mar. 12, 2007

(51) Int. Cl. G01N 1/00

(52) U.S. Cl. 600/584; 705/2

(57) ABSTRACT

In one embodiment of the invention, a booth for bio-testing is provided. The booth comprises a specimen collection mechanism for collecting a biological specimen; and a storage mechanism to store the collected specimen for analysis.

### FIELD OF THE INVENTION

Embodiments of the invention relate to bio-testing.

### BACKGROUND TO THE INVENTION

Bio-testing involves the collection of a biological sample from a person and subsequent analysis of the collected sample. The biological sample may include a blood sample, a skin sample, a urine sample, a saliva sample, a stool sample, a skin sample, a hair sample, etc.

### BRIEF DESCRIPTION OF THE DRAWINGS

The invention is now described, by way of non-limiting example, with reference to the accompanying drawings wherein

FIG. 1 is a drawing of a perspective view of one embodiment of a booth according to the invention; and

FIG. 2 is a drawing of the booth of FIG. 1, in use.

### DETAILED DESCRIPTION OF THE INVENTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, embodiments of the invention provide for a bio-testing booth. In one embodiment of the invention, the booth may be deployed in a public area, and may be used to collect a biological specimen from a person for analysis. A report of the analysis may then be provided to a person from whom the sample was collected, or to another person. The biological specimen (“the sample”) may include a blood sample, a hair sample, a saliva sample, a urine sample, a stool sample, etc.

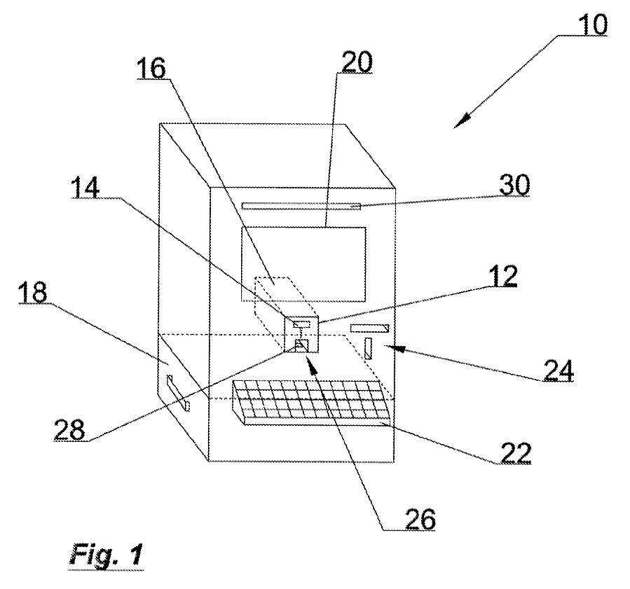

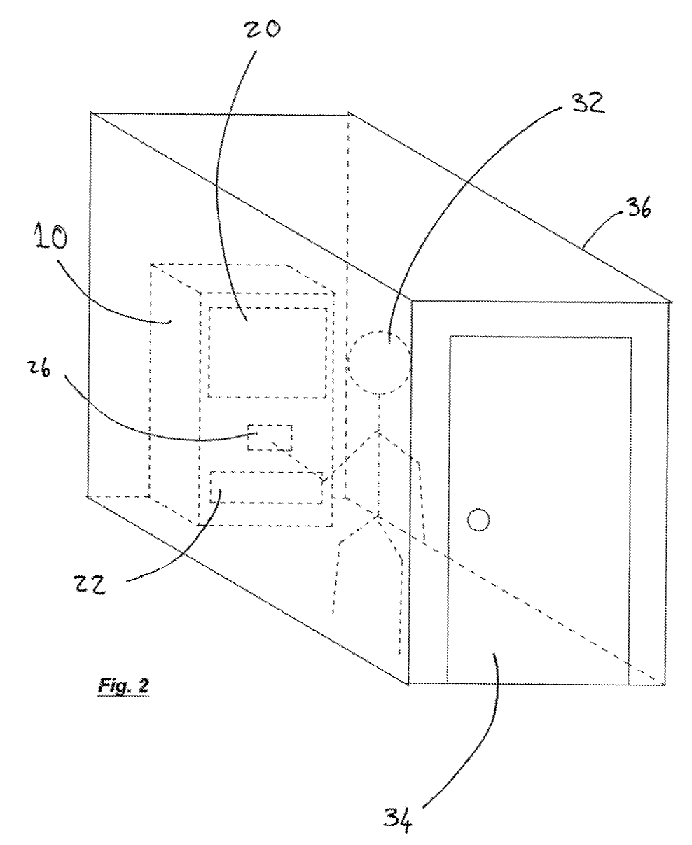

Turning now to the drawings, there is shown an embodiment of the booth 10. FIG. 1 shows one embodiment and FIG. 2 shows the booth 10 of FIG. 1 installed in a private enclosure 36 to ensure the privacy of the user 32. In the embodiment shown in the drawings, the booth 10 comprises a collection mechanism 12 to collect the sample. For descriptive convenience, the sample comprises a blood sample. The collection mechanism 12 comprises an aperture 26 in which a person 32 may insert a finger for sample collection. The collection mechanism 12 further comprises a needle 14 for piercing the inserted finger and a slide 28 for collecting a drop of blood.

One embodiment of the booth 10 also comprises a user interface in the form of a display 20 and a keypad 22. The user interface allows the user 32 to input and be presented with information. One embodiment of the booth comprises a reporting mechanism 30 in the form of a printer to provide the user 32 with a hardcopy of a result of the analysis. In different embodiments of the invention, the reporting mechanism 30 may comprise a download mechanism allowing the user 32 to download the report directly to a storage device, such as a USE (Universal Serial Bus) flash drive.

In one embodiment of the invention, the needle 12 automatically collects the sample when the user 32 inserts a finger. The automatic collection of the sample may involve the needle 14 being actuated by a needle displacement mechanism, such as an electromechanical mechanism, e.g. a solenoid. The collection mechanism 12 may comprise a sensor to sense when a finger is inserted into the aperture 26. When a finger is sensed, the collection mechanism may indicate to the user 32 via the display 20 when the needle will prick the finger. For example, when the finger is sensed, the display 20 indicates that the user 32 must keep his/her finger in position and may show a countdown when the needle displacement mechanism will lower the needle 14.

In one embodiment of the invention, the needle 14 is only lowered by the needle displacement mechanism when the user 32 provides an instruction via the keypad 22. For example, the user inserts a finger and presses a key on the keypad 22. When the key is pressed, the needle displacement mechanism lowers the needle 14 to prick the finger.

In an embodiment of the invention, the booth 10 comprises an analyzer 16 to analyze the collected sample. The analyzer 16 may analyze the sample for specific factors, such as pathogens, presence of drugs or stimulants, etc. The user 32 may specify what the analyzer 16 must analyze for. The user 32 may specify what analysis to perform via the user interface 22. For example, the display 20 shows a list of tests which the analyzer 16 is able to perform. The user 32 may use the keypad 22 to select a particular test.

In one embodiment, the analyzer 16 may require time to analyze the sample. The result is not available at the time of analysis. In such an embodiment, the reporting mechanism 20 may only report the result of the analysis at a later stage after collection of the sample. The user interface 22 may be user to arrange a time at which the result is reported. For example, a sample is collected from the person 32, and the display 20 reports that the result will only be available after an hour. The person 32 is then able to specify via the user interface 22 that he/she will visit the booth 10 again after two hours, for example, to collect the result of the analysis. In one embodiment, the display 20 and/or reporting means 30 may provide the person 32 with a unique PIN (Personal Identification Number) for identification purposes when the report is collected at a later stage. For example, after the sample is collected, the display 20 displays a PIN number and a time when the report will be available. When the person 32 returns at a later stage, he/she enters the PIN via the keypad 22 and the report is displayed and/or printed.

In one embodiment, the user interface 22 may be used to submit contact details where a report of the analysis must be sent. The contact details may include a postal address, a residential address, an e-mail address, a telephone number, etc. The contact details may be that of the person 32 from which the sample is collected. The contact details may also be that of another person, such as a doctor, a nurse, a pathologist, a medical aid, etc.

In an embodiment of the invention, the booth 10 may also comprise a storage mechanism 18. In one embodiment of the invention, the storage mechanism 18 comprises an enclosure to securely store the sample after collection. The storage mechanism 18 may store the collected samples for later analysis done after the time of collecting the sample. For example, the collection mechanism 12 collects the sample and stores the sample in a secure enclosure for collection. The sample is collected and taken to a laboratory for analysis. It is to be appreciated that, in such an embodiment, the booth 10 may not include the analyzer 16, or the analyzer 16 is unable to perform the requested or necessary analysis.

In another embodiment of the invention, the booth 10 comprises the analyzer 16, and the storage mechanism 18 is used to store the sample after it has been analysed. For examples the storage mechanism 18 stores the sample for archive purposes in a remote storage facility. The storage mechanism 18 may store the sample as medical waste, i.e. the sample is collected and destroyed.

In one embodiment of the invention, the booth 10 may comprise an indexing mechanism to index each collected sample to a person from whom the sample was collected. In one embodiment, the indexing mechanism may comprise a labeling mechanism to label the slide 14, for example. The slide 14 may be labeled with information received via the user interface 22, e.g. name of the person, test to be performed, contact details, etc.

In one embodiment of the invention, the booth 10 may comprise a payment mechanism 24. The payment mechanism 24 allows the person 32 to submit payment for the sample collection and/or the analysis of the sample, in the embodiment of the invention shown, the payment mechanism 24 comprises two slots, one for receiving coins and the other for receiving cash. In one embodiment, the payment mechanism 24 may include a credit card slot. In another embodiment of the invention, the booth 10 may be connected to the Internet to allow a person to conduct Internet banking to submit payment.

The booth 10 may be installed in any public location, such as a shopping mall, an airport, a gym, etc.

For illustrative purposes and without loss of generality, one example of operation of the booth 10 is described. The booth 10 is installed inside a private enclosure 36 with a door 34 to allow privacy. The enclosure 36 may be located in a shopping mall, for example. The person 32 enters the enclosure 36 and closes the door 34. The display 20 displays that the booth 10 is able to perform a blood analysis for HIV (Human Immunodeficiency Virus). The person 32 submits payments with a credit card via the payment mechanism 24. The person 32 uses the user interface 22 to select a blood analysis.

The person 32 now inserts a finger into the aperture 26 of the collection mechanism 12 and the display 20 indicates to the person 32 a timer showing when the sample will be collected. When the displayed timer runs out, the needle 14 pricks the inserted finger and the person squeezes a drop of blood onto the slide 28. The sample is analyzed by the analyzer 16 for the HIV pathogen. Once the sample is analysed, it is stored by the storage mechanism 18 for later collection and destruction as medical waste. The result of the analysis is now displayed on the display 20 to the person and the reporting mechanism 30 prints a hard-copy for the person 32.

Although only certain embodiments of the invention have been described herein it will be understood by any person skilled in the art that other modifications variations and possibilities of the invention are possible without departing from the broader spirit of the invention. Such modifications, variations and possibilities are therefore to be considered as falling within the spirit and scope of the invention and hence forming part of the invention as herein described and/or exemplified. Accordingly, the specification and drawings are to be regarded in an illustrative sense rather than in a restrictive sense.

1. A booth comprising:
a specimen collection mechanism for collecting a biological specimen; and
a storage mechanism to store the collected specimen for analysis.

2. The booth of claim 1, wherein the collection mechanism automatically collects the specimen.

3. The booth of claim 1, further comprising an analyzer to analyse the collected specimen.

4. The booth of claim 3, further comprising a reporting mechanism to report a result of the analysis.

5. The booth of claim 4, wherein the reporting mechanism reports the result at the time of analysis.

6. The booth of claim 4, wherein the reporting mechanism reports the result after the time of analysis.

7. The booth of claim 6, further comprising a user interface to allow a person to schedule a reporting time for the result.

8. The booth of claim 4, wherein the reporting mechanism is selected from the group consisting of a printer, a display and a speaker.

9. The booth of claim 1, further comprising a user interface whereby a person is able to submit contact details for receiving a result of the analysis.

10. The booth of claim 9, wherein the user interface accepts contact details selected from the group consisting of a telephone number, a fax number, a postal address and an e-mail address.

11. The booth of claim 1, further comprising a user interface whereby a person is able to select a specific type of analysis to be performed on the collected specimen.

12. The booth of claim 1, wherein the specimen collection mechanism comprises a needle and slide for collecting a blood specimen.

13. The booth of claim 12, wherein the storage mechanism comprises an enclosure for receiving the slide.

14. The booth of claim 12, further comprising an indexing mechanism to index each collected sample with a slide.

15. The booth of claim 1, further comprising a payment mechanism whereby a person is able to submit payment for collection of the specimen.

16. A booth installed at a public location comprising:
a specimen collection mechanism for collecting a biological specimen;
an analyzer for analyzing the collected specimen; and
a reporting mechanism to report a result of the analysis to the person.

17. The booth of claim 16, wherein the collection mechanism automatically collects the specimen.

18. The booth of claim 16, further comprising a user interface whereby a person is able to select a specific type of analysis to be performed on the collected specimen.

19. The booth of claim 16, wherein the reporting mechanism is selected from the group consisting of a printer, a display and a speaker.

20. The booth of claim 16, wherein the specimen collection mechanism comprises a needle and slide for collecting a blood specimen.
